(19) United States
(12) Patent Application Publication
(10) Pub. No.: US 2002/0113014 A1
(43) Pub. Date: Aug. 22, 2002

(54) Apparatus and methods for separating liquids from solids

(76) Inventor: Willie Stroup, Maceo, KY (US)

Correspondence Address: HOWREY SIMON ARNOLD & WHITE LLP, BOX 34, 1299 PENNSYLVANIA AVENUE NW, WASHINGTON, DC, 20004, US

(21) Appl. No.: 10/050,907

(22) Filed: Jan. 18, 2002

Related U.S. Application Data
(60) Provisional application No. 60/262,377, filed on Jan. 19, 2001.

(51) Int. Cl. B01D 63/00

(52) U.S. Cl. 210/637; 210/742; 210/749; 210/774; 210/149; 210/198.1; 210/257.2; 210/321.65

(57) ABSTRACT

The invention is a filter device for removing water from sludges, slurries, or other suspensions, and may include a hydraulic press and/or a membrane and vacuum system for applying a pressure to the sludge or slurry, heating elements for heating and drying the sludge or slurry, vibrating elements for agitating the sludge or slurry, and air injectors for agitating and drying the sludge or slurry.

### PRIORITY DATA

This application claims priority to U.S. Provisional Patent Application No. 60/262,377, filed Jan. 19, 2001.

### BACKGROUND

Many industrial applications generate by-products that include mixtures of solids, liquids, and/or gases. These mixtures are commonly called sludges, slurries, suspensions, or emulsions, often depending on whether the solids are by-products to be disposed of or products to be recovered. The scope of potential uses of both sludges and slurries will be substantially increased by removal of the liquid component from the solid component. An increased value of dry sludge solids over wet sludges is reflected in their decreased weight, which leads to decreased disposal and transportation costs. Additionally, if sludge material can be sufficiently dried, it may be sold in secondary markets. Like sludges, dry solids from slurries are more valuable than wet slurries because of their decreased weight and consequent decreased transportation costs, but also because many slurries must be dried before the solids in them can be used.

Sludge wastes present expensive disposal problems to the industries that generate them. The solid components of sludge wastes are typically present as much less than half of the total weight of the sludge, whereas water is typically the greatest component. Such unprocessed sludge cannot be disposed of in landfills whose regulations require the water content of solid waste to be below specified levels. Even if landfills with more permissive regulations can be found, it is much more expensive to transport and dispose of unprocessed sludge than just its solid components because freight carriers and disposal sites usually charge for their services at rates proportional to the weights of the materials hauled and disposed of.

Industry has worked around these problems using methods that are not always environmentally sound. For example, many industries dump waste sludge into sludge ponds, enormous concrete or plastic lined pools into which sludge from an industrial facility flows and is stored. These sludge ponds must be periodically dredged and the sludge disposed of. Such a solution may not be satisfactory from an environmental perspective if the pool lining fails or if the dredged sludge is disposed of in landfills, as heavy metals and other undesirable industrial waste products can seep into the groundwater and contaminate potential sources of underground drinking water.

Industrial sludge ponds suffer from other practical difficulties. They take much longer to separate water from solids for a given volume of sludge than active separation devices. A much larger area must be used to keep up with output for any given waste flow rate than if an active separation is used. However, most active separation devices cannot be cheaply and effectively scaled up to handle industrial waste flow rates, but the alternative of purchasing enough active separation devices may be prohibitively expensive. Thus there is a need in the art for active separation devices and methods that can process sludge waste produced at industrial rates.

In some industrial applications, the solid itself is the product that must be recovered. For example, in coal and mineral slurries, it is desirable to remove as much of the water from the slurries as possible for efficiency in transportation, and in the case of coal slurries, for combustion efficiency. Mineral slurries must likewise be dried for the mineral resources therein to be exploited. Furthermore, solids from sludge can sometimes also be made useful products worth recovering. The need to dispose of sludge might in some cases be eliminated altogether provided the water and solid components can be sufficiently separated because the solid components may be commercially valuable or at least useable in other industrial applications (e.g., as filler in concrete mixtures).

Therefore, there is a need for efficient methods and devices for separating water from solids in sludge waste or slurries. There is also a need for methods and devices capable of substantially eliminating water from slurries or sludge wastes to produce a substantially dry product or by-product that may be used in other applications. Furthermore, there is a need to provide a solution for massive scale industrial waste treatment that does not involve dumping waste into a sludge pond.

Some devices for separating water from solids in sludge waste rely on gravity filtration. These devices typically include a sludge holding chamber with openings in the bottom and sides, where the openings are covered with a filter material. Gravity pulls the sludge, but the particulate matter is blocked by the filter. Water that contains substantially reduced quantities of solids flows through the filters into the openings, while the bulk of the solids remain in the holding chamber to be collected later. Examples of these types of devices are described in U.S. Pat. No. 4,116,838 to Lazzarotto; U.S. Pat. No. 4,176,066 to Sloan; U.S. Pat. Nos. 4,929,353; 5,707,535; and 6,004,461 to Harris; U.S. Pat. No. 5,156,749 to Williams; and U.S. Pat. Nos. 5,595,654 and 5,681,460 to Caughman, Jr.

Some devices employ alternative means to gravity filtration for separating water from solids. One such device is the subject of U.S. Pat. No. 5,771,601 to Veal et al. This device uses a gas stream to establish turbulent flow across a slurry bed in order to reduce the moisture content of the slurry. The slurry bed may be part of a centrifuge or a vibratory conveyor to enhance moisture reduction. The vibratory conveyor of the Veal patent is an extended conveyor belt bed that moves the slurry through a downwardly inclined tunnel containing a processing zone in which the gas stream is injected to strip moisture.

Other alternatives to gravity filtration for separating liquids from solids include vacuum filtration. One type of vacuum filtration device is a vacuum rotary drum, such as that described by Davis in U.S. Pat. No. 4,008,158 or that described by Baird et al. in U.S. Pat. No. 5,470,472. U.S. Pat. No. 4,402,834 to Bastgen et al. discloses a method by which a vacuum rotary drum is used to initially thicken a sludge, and further dewatering is accomplished through an in-line conveyer process that might include vacuum, centrifugation, or pressure. U.S. Pat. No. 5,227,060 to Roy et al. discusses a vacuum filtration apparatus in a rigid, air-tight chamber for removing fluid from fluid-containing compositions and for storing the composition after the fluid is removed. U.S. Pat. No. 5,426,864 to Svehaug et al. describes a vacuum filtration apparatus in which a conveyer belt passes over a vacuum pipe, and then under a roller press, in a two step in-line process to dry fine particle suspensions. U.S. Pat. No. 5,545,338 to Ginn et al. describes a vacuum filtration method by which a filter-covered cylinder is immersed into a flowing container of slurry and a vacuum is pulled inside the cylinder, causing water to flow from the slurry into the cylinder. U.S. Pat. No. 5,173,196 to Macrae describes a process of high-pressure pumping of sludge through a filter.

The aforementioned designs tend to be slow, and usually require many such devices in order to keep up with the sludge output of a given industrial process. Some designs would require a prohibitive number of devices for processing sludge waste at rates required by plant-sized industrial sludge producing processes. The number of devices required increase costs for the industry using them because greater numbers of devices require a larger initial investment, greater maintenance, as well as larger physical areas in which to install the devices. If fewer devices are used, then the sludge processing step may be the bottleneck for the industrial process. Furthermore, the prior art devices may not provide solids that are adequately dry for purposes of marketability for other industrial applications. Thus there is a need in the art for fast and efficient devices for separating water from solids that can produce solids that are sufficiently dry to be used in other applications.

### SUMMARY OF THE INVENTION

Accordingly, the present invention is directed to an apparatus and method for separating liquids from mixtures of liquids and solids that substantially eliminates one or more of the problems arising from the limitations and disadvantages of the related art. The invention is particularly suited for separating water or other liquids from solids in all types of sludge wastes or in slurries. Throughout this application, such mixtures of solids and water will be referred to as sludge, but this term is not to be construed to exclude other kinds of mixtures of liquids and solids, such as slurries.

One object and purpose of the present invention is to provide an alternative to industrial waste sludge ponds in order to eliminate industrial reliance on such sludge ponds. This invention can completely replace industrial sludge ponds, thus eliminating the damage to the environment that these facilities produce, and reducing the problems of storage and disposal of industrial wastes.

Another object and purpose of the present invention is to provide an increased sludge processing rate to allow the same rate of production of industrial wastes or products while requiring fewer processing units than the processing units of the prior art. This provides the advantage of requiring smaller physical areas for installing the devices than for the devices of the prior art, as well as fewer devices to maintain. Furthermore, the relative simplicity of the design and implementation of the present invention allows it to be easily adapted to industrial scale processes, whereas to adapt the separation techniques of the prior art to industrial scale processes would be prohibitively expensive.

Another aspect of the invention is the greater drying capacity of the processing units of the invention which provides drier solid by-products that may be commercially marketable, thus not only saving transportation and disposal costs, but also providing an additional source of revenue. The greater drying capacity of the processing units of the invention will also provide drier products in cases where the processed material is a final product.

The invention can also be used to compress particulate solids that are already substantially dry, but that are less dense than they could be. Such solids can be compressed using the processing units of the invention, thus creating more tightly packed particulate solids and saving space, for example, when storing or transporting the solids.

The main components of the invention include a chamber, the main tank, into which sludge is initially deposited. The chamber may be constructed with drains or conduits through which water can drain into one or more water collection tanks. Separating the conduits from the chamber are filters that act to hold the solid components of the sludge in the chamber, while allowing water from the sludge to pass through to the conduits to a collecting tank and ultimately to a holding tank.

One embodiment of the invention includes a membrane, preferably an airtight membrane, covering the sludge-filled chamber. Preferably, the membrane forms an air-tight seal within the chamber through substantial contact between the membrane and the tops of the walls of the chamber. A vacuum pump is attached to the conduits, and a partial vacuum is drawn through the conduits, thus producing a pressure differential between the top of the sludge and the bottom of the chamber. The membrane acts to distribute the pressure differential across the surface of the sludge in the chamber, allowing atmospheric pressure to squeeze moisture from the sludge, and to thus accelerate the filtration process.

Another aspect of the invention may include a hydraulic press component. The hydraulic press can be lowered into the sludge-filled chamber to apply external pressure on the sludge from above. This pressure accelerates the filtration process by squeezing water out of the sludge, through the filters, and into the conduits. In one embodiment, the hydraulic press is used in conjunction with a membrane as described in the preceding paragraph, thus adding additional external pressure to the pressure differential produced by the combination of the membrane and the vacuum pump.

Other features to accelerate the filtration process may be present in the chamber, membrane, or hydraulic press (if present). The invention may include heating elements, either dispersed throughout the chamber, as part of the membrane, and/or as part of the press, for raising the temperature of the sludge. This has the dual effect of accelerating the filtration process and causing substantial drying by evaporation. Related aspects of the invention optionally include a thermometer for measuring the temperature of the sludge and a thermostat for adjusting the quantity of heat delivered to the sludge.

The invention may also include vibrating elements dispersed throughout the chamber, as part of the press, and/or as part of the membrane. The vibrating elements agitate the sludge, thus accelerating the filtration process.

The invention may further include air injectors dispersed throughout the chamber, as part of the press, and/or as part of the membrane. The air injectors both accelerate the filtration process by further agitating the sludge and accelerate the drying process by providing a blow-drying mechanism. The air injectors may include either high pressure air injectors or high volume air injectors or both. Bursts of air or bursts of water into the main tank chamber through the filters from air or water injectors in the conduits can be used to clean the filter of fine particulate matter that may block water from passing through during filtration. Liquids and gases other than air may be introduced to speed filtration, or to change the composition of a slurry.

One aspect of the invention includes a fully functional, portable scale model of the full sized separation apparatus. This model apparatus can be used to study and analyze sludges generated at particular industrial sites in order to determine whether the apparatus would be a substantial improvement over separation apparatus already in place. If the data indicate that the apparatus of the invention is a substantial improvement, further tests can indicate the number of permanent full sized apparatuses that would be required to process sludge at the rate the sludge is generated. The model apparatus can also be used to generate a substantially dry product in order to determine whether that dry product has enhanced commercial value.

The model apparatus can be used to determine the optimal operating conditions for the full scale apparatus. Such a use may allow the full scale apparatus to be made more cheaply because it should not require the same measurement devices that the model apparatus would have. For example, if the model apparatus has moisture sensors, temperature probes, and dust probes, then the model apparatus can be used to determine the optimal press pressure, sludge temperature, and processing time. These variables can then be recorded and used with the full scale apparatus, and the full scale apparatus would therefore not need the sensors and probes to make that determination.

It is to be understood that both the foregoing general description and the following detailed description are exemplary and explanatory, and are intended to provide further explanation of the invention as claimed.

The accompanying drawings are included to provide a further understanding of the invention and are incorporated in and constitute a part of this specification illustrating embodiments of the invention. The drawings, together with the description, serve to explain the principle of the invention, but are not meant to limit the scope of the claims.

### DESCRIPTIONS OF THE DRAWINGS

FIG. 1 is an elevational view of an industrial application of one embodiment of the sludge filtration apparatus of the present invention;

FIG. 2 is an elevational view of one embodiment of the main tank chamber;

FIG. 3 is a longitudinal sectional view of one embodiment of the main tank chamber;

FIG. 4 is a transverse sectional view of one embodiment of the main tank chamber;

FIG. 5 is a detailed longitudinal sectional view of a headwall (sludge-input side wall) in one embodiment of the main tank chamber;

FIG. 6 is a detailed longitudinal sectional view of a separator (inner) wall in one embodiment of the main tank chamber;

FIG. 7 is a detailed longitudinal sectional view of an egress wall in one embodiment of the main tank chamber, including the lower section of a vehicle-access ramp;

FIG. 8 is a detailed longitudinal sectional view of a ramp wall in one embodiment of the main tank chamber, including the upper section of a vehicle-access ramp;

FIG. 9 is a detailed transverse sectional view of a trough wall in one embodiment of the main tank chamber;

FIG. 10 is a transverse sectional view of one embodiment of the invention that includes a press; and

FIG. 11 is a schematic transverse sectional view of an embodiment that includes a press and pump system.

### DETAILED DESCRIPTION

The present invention involves an apparatus and methods for reducing the quantity of water in a suspension. A suspension is any combination of particulate matter (solids) suspended in or containing significant quantities of water or any other liquid. While it is envisioned that the primary use of the invention is to dewater sludges or slurries, it is anticipated that the device will be equally useful in any application that requires removal of liquids from any mixture of liquids and solids.

The invention involves providing a chamber for holding sludge, which may flow from a waste discharge pipe into the chamber. The chamber may comprise a plurality of conduits, separated by a filter material from the main body of the chamber. When the chamber is full, the waste discharge is redirected to another chamber, or is temporarily stopped. An air-tight membrane may drawn over the chamber full of sludge, or may be permanently in place over the sludge, with an airtight seal between the chamber and the membrane. A vacuum is applied to the chamber through the conduits, and the force of atmospheric pressure on the membrane causes the liquid component of the sludge to be forced through the filters separating the conduits from the main body of the chamber. The vacuum may be released and pulled several times in order to achieve the desired level of dryness for the solid component of the sludge. Additionally, heat or air injections may be employed to speed the separation process. In one embodiment of the invention, heat and vacuum are employed to induce a liquid to vapor phase change in the sludge, allowing extremely rapid removal of the liquid component from the solid component of the sludge.

Once the solid component of the sludge reaches a sufficient level of dryness, the membrane may be removed from the chamber, or an alternative means for access to the chamber may be opened. The dewatered sludge should consist substantially of the solid component of the sludge, and may be removed from the chamber. If necessary, the filters separating the conduits from the main body of the chamber can be replaced. The chamber is then once again ready to receive waste sludge from the waste discharge pipe.

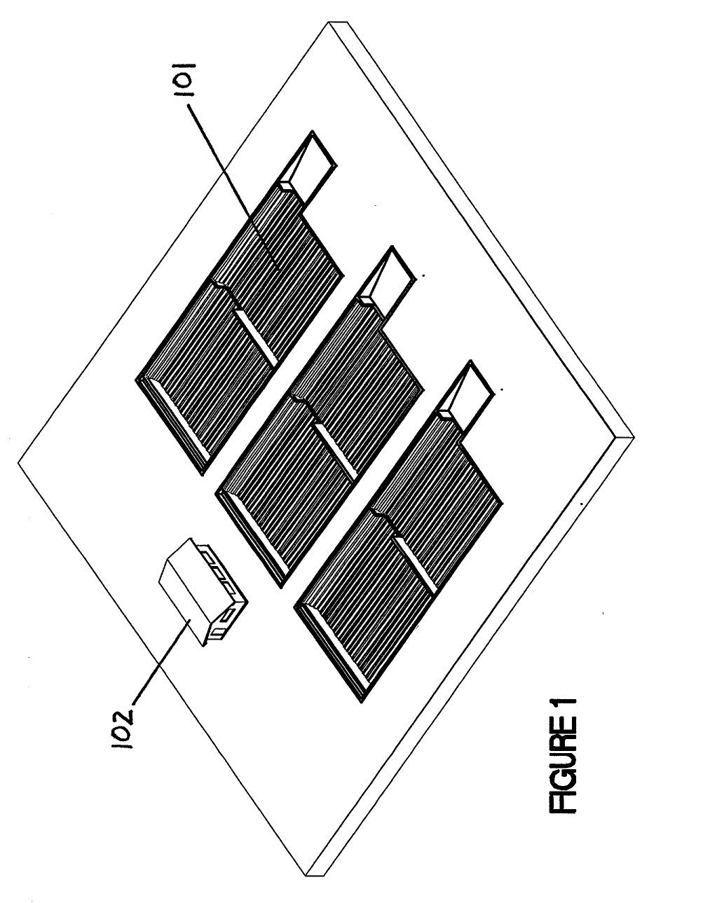

The present invention is particularly useful in industrial applications requiring constant processing of waste sludges. FIG. 1 depicts one industrial application in which a plurality of main tank chambers (101) are buried in the ground on the industrial site where the sludge to be processed is produced. The chambers may be buried so that when full of sludge to be processed, the sludge level remains below ground level. The chambers may alternatively be above ground, depending on the height of the waste sludge source. A nearby facility (102) may house instruments for monitoring the dewatering process as well as pump equipment and other equipment for use in the dewatering process, as described below.

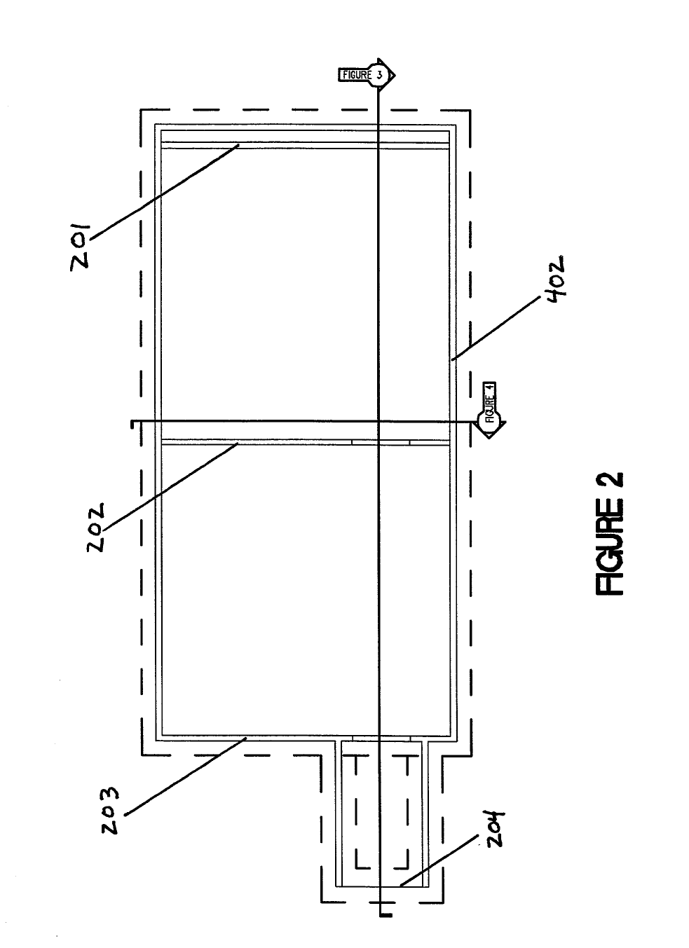

One component of the invention is a chamber (101) for holding the suspension, the main tank chamber. In a preferred embodiment of the invention, the chamber is open at the top and is comprised of four walls and a floor, as depicted in FIGS. 1-4. The chamber can be made of any suitably strong material that is resistant to leaking and to reaction with the suspension to be used with the apparatus. Examples of materials from which the chamber may be constructed include concrete, plastic, steel, or other metal.

In a preferred embodiment, the chamber is constructed of concrete. Preferably the main chamber is made of prefabricated concrete. The main chamber can be comprised of prefabricated components that are of a size that is easy to transport to the industrial site. The components may then be assembled at the industrial site. If warranted by the projected rate of sludge produced by the industrial site, and as shown in FIG. 1, multiple chambers may be used. This arrangement has the benefit of providing alternative sludge receptacles for when one is full and undergoing the drying cycle.

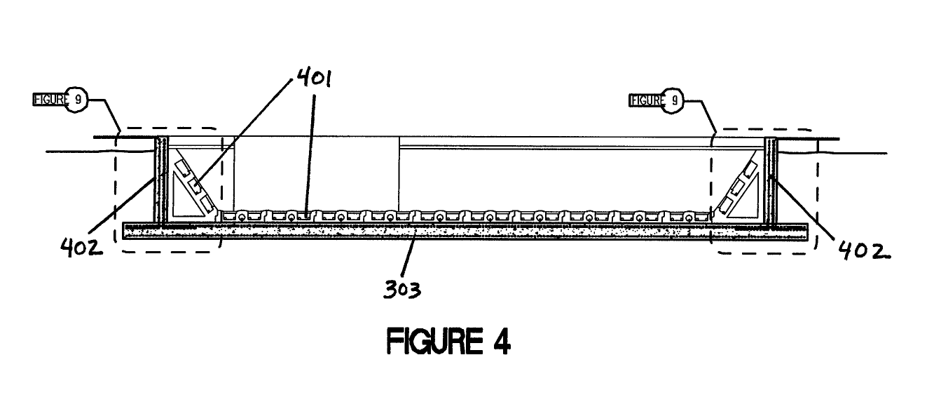

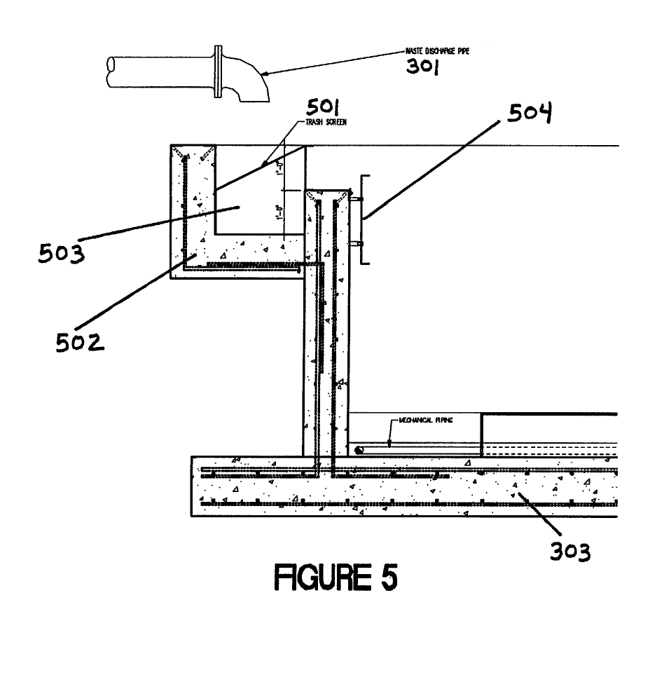

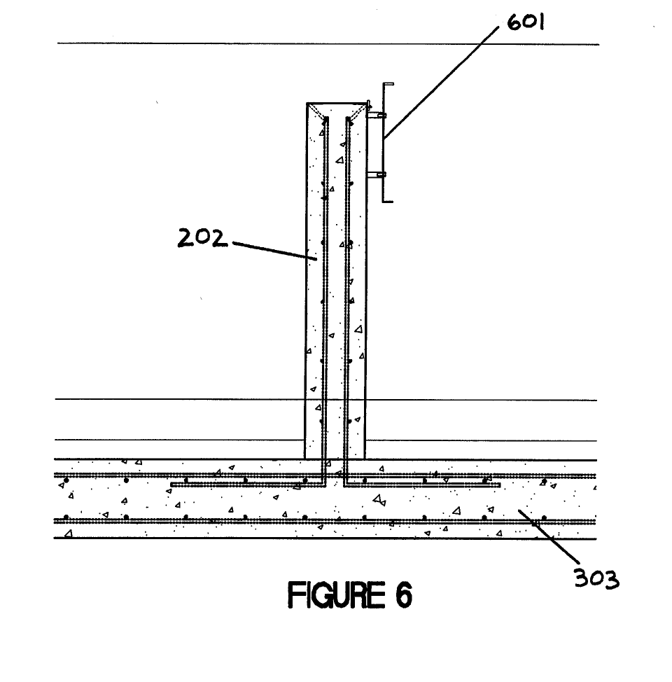

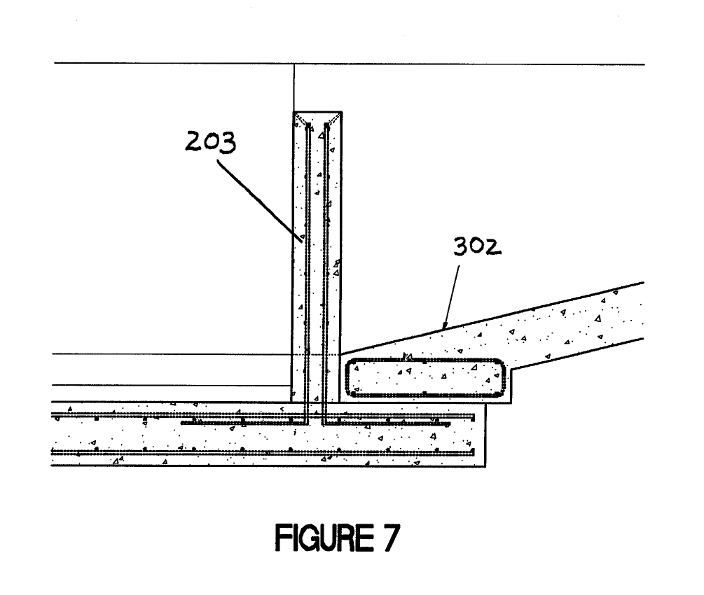

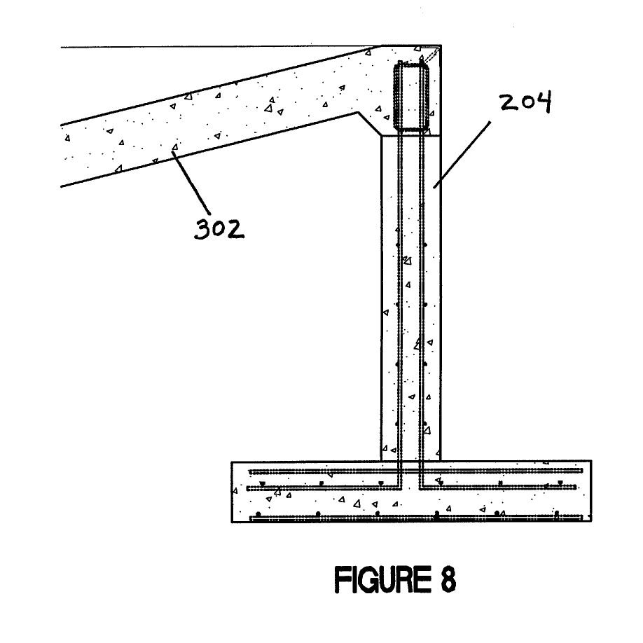

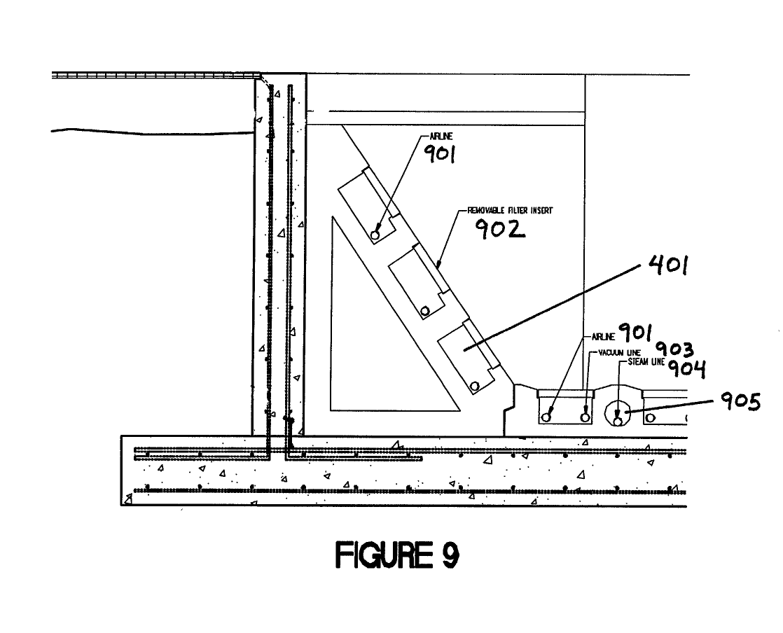

The trough (side) walls (402) of the chamber make an obtuse angle with the floor of the chamber, as shown in FIGS. 4 and 9. In this embodiment, sludge flows from a waste discharge pipe (301) into the main tank chamber over the headwall (201), and a weir (504) that slows and directs flow across the chamber and downward to filters, as shown in FIG. 5. This embodiment comprises at least one separator wall (202), as shown in FIG. 6. Also in this embodiment, on the opposite side of the chamber from the headwall is an egress wall (203), as shown in FIG. 7, and a ramp wall (204), as shown in FIG. 8. In this embodiment, the headwall, separator, egress, and ramp walls of the chamber are all substantially perpendicular to the floor of the chamber.

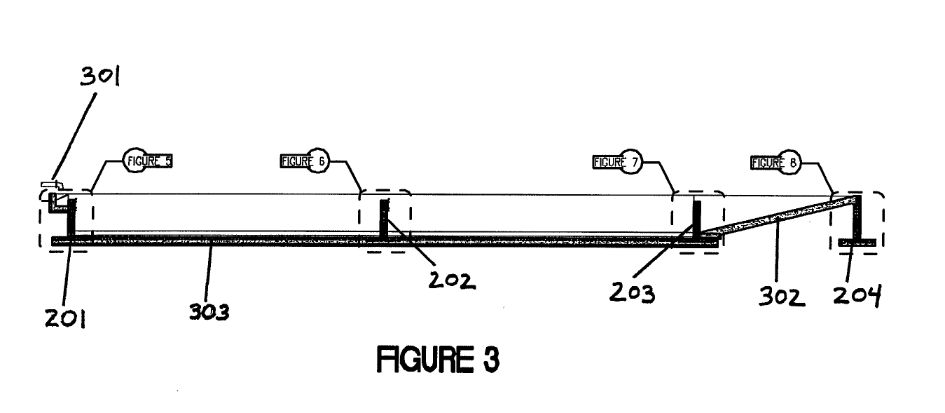

FIG. 3 is a longitudinal sectional view of the chamber (101). This embodiment includes a ramp (302) to allow vehicular access to the chamber (101), for example, by a backhoe loader or front shovel, to remove dry solids from the chamber after the dewatering process is complete. Other access means for removing dry solids from the chamber after the dewatering process would also be acceptable. For example, dry solids may be scooped out of the chamber from above.

In an alternative embodiment, the chamber is made of an air-tight, flexible material that is resistant to reaction with the suspension to be used with the apparatus. Suitable materials include rubber and plastic. In this embodiment, the flexibility of the chamber allows the sludge filtration apparatus of the invention to use atmospheric pressure to squeeze moisture from the solids in the sludge through application of a partial vacuum to the air-tight chamber.

One embodiment of the invention comprises at least one conduit for directing water from the suspension away from the chamber. For example, FIGS. 4 and 9 show how conduits are placed in a preferred embodiment of the present invention. The conduit can be any means for directing water from the suspension away from the chamber including, but not limited to, a pipe or a gutter. In a preferred embodiment, the chamber contains multiple conduits (401) extending the length of the chamber from the headwall to the egress wall and extending across both trough walls (402) of the chamber as well as across the floor of the chamber (303). In a preferred embodiment, the conduits are gutters carved out of or molded into the side walls and floor of the chamber that extend from the front end of the chamber and empty into a collection tank at the back of the chamber.

In the alternative embodiment in which the chamber is comprised of a flexible, air-tight material, the conduit can be any means by which a partial vacuum can be applied to the inside of the chamber, and by which liquid can leave the chamber.

Another component of the invention is a filter material (902) separating the conduit from the chamber, as shown in FIG. 9. This filter material can be any material suitable for blocking solid particulate matter from a suspension, thus holding the solid particulate matter in place, but that allows water from the suspension to pass through. In a preferred embodiment, the filter material (902) is a synthetic polymer based fabric such as a woven geo filter. Other suitable filter materials that are useful for practicing the invention are well known to those skilled in the art, for example, any perforated material including perforated sheet metal. An important consideration when selecting a filter for use with this invention is the size of the particulate (solid) matter in the suspension to be separated. Finer particulate matter would require a finer mesh filter in order to prevent the particulate matter from passing through the filter with the water.

In a preferred embodiment, the invention includes a flexible or non-flexible membrane that is substantially air-tight. In a preferred embodiment, the membrane is a removable, flexible, substantially air-tight membrane, for example, natural or synthetic rubber. Other suitable membrane materials would be readily apparent to those skilled in the art. Preferably, the membrane is placed over the chamber and fastened to the headwall (201), egress wall (203), and side walls (402) in a substantially air-tight way, for example, using bolts, gaskets, or any other suitable fastening means. When a vacuum is applied to the contents of the chamber through vacuum pipes (903) within the conduits (401), the difference in pressure inside the chamber and atmospheric pressure is substantially evenly distributed across the surface of the contents of the chamber by virtue of the membrane. In this way, the membrane and the vacuum applied to the inside of the chamber act together to allow atmospheric pressure to squeeze the contents of the chamber, thus forcing water from the chamber, through the filter (902) separating the conduit (401) from the chamber, into the conduit (401), and out of the chamber. In an alternative embodiment, the membrane is flexible and substantially air-tight, fastened to a rigid platform capable of being lowered into the chamber in a manner that would create a substantially air-tight seal between the membrane and the walls of the chamber. The platform may comprise one or more heating elements, high pressure air injectors, high volume air injectors, and/or vacuum lines.

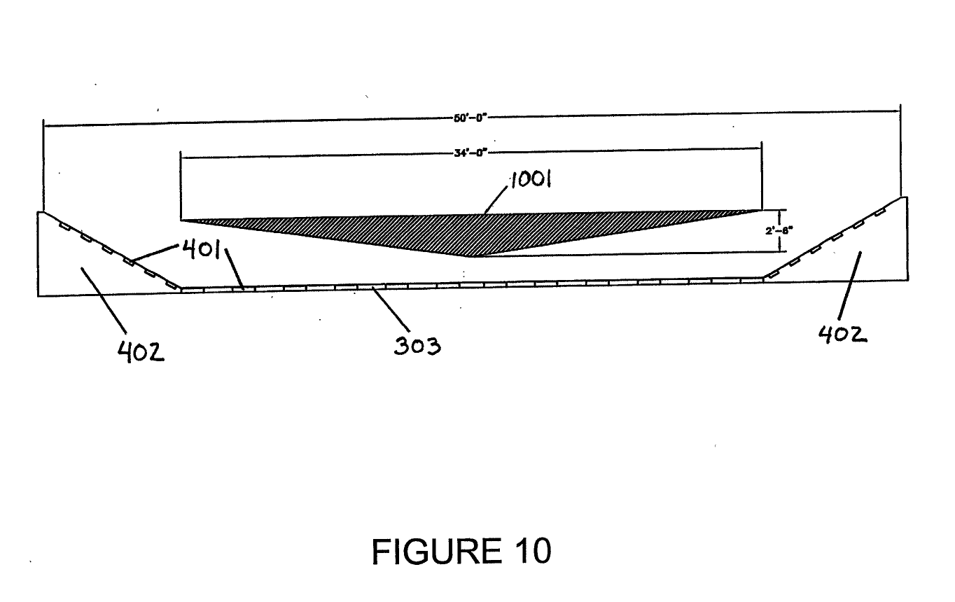

In the embodiment of the invention shown in FIG. 10, a wedge-shaped press (1001) is positioned over the main tank chamber in an orientation such that one of the vertices of the press points down toward the floor of the chamber and the press extends substantially the length of the chamber. The invention is not limited by the shape of the press, and one of ordinary skill in the art will recognize that the press could be shaped differently to accomplish the task. The press may be fashioned out of any suitable material such as plastic, metal, or concrete. In a preferred embodiment, the press is fashioned out of concrete. The press may be lowered into the chamber so as to exert a force from above on the suspension held within the chamber, thus accelerating the release of water from the suspension. The invention encompasses a means for lowering the press into the chamber. In a preferred embodiment, the press is attached to a hydraulic mechanism which allows the application of much more force than the weight of the press alone would provide. Such a hydraulic mechanism can serve the dual purpose of first, lowering the press into the chamber, and second, applying additional force to the contents of the chamber.

In one embodiment of the invention, there is at least one heating element for increasing the temperature of the suspension contained in the main tank chamber, as shown in FIG. 9. Heating the suspension increases the rate of drying by both increasing the rate of filtration and increasing the rate of evaporative drying. The heating element may be an electric resistive heating element, a gas heater, or any other suitable heating means. In a preferred embodiment, the heating element consists of one or more steam lines (904) embedded in the floor and walls of the main tank chamber, thus allowing heat to be provided to elevate the temperature of the suspension contained therein. In an alternate embodiment, the heating element may consist of one or more resistive heaters or steam lines embedded in a press (1001).

In one embodiment, the invention comprises one or more temperature probes for measuring the temperature of the suspension. An optional feedback loop connects the temperature probe to the heating element in order to maintain the suspension at within a temperature range as set by a thermostat. In the preferred embodiment, the temperature probe is a resistive thermometer attached to the press, and extends downward from the probe toward the floor of the main tank chamber.

In one embodiment, the invention comprises at least one moisture sensor (402) for measuring the moisture level of the suspension. The moisture sensor is useful for determining when the drying process is sufficiently complete. The moisture sensor technology is well developed and known to those of skill in the art. Any suitable moisture sensor may be used with the invention, including, but not limited to, pressure extractors, time domain reflectometers, fluid conductivity or dielectric constant measurement devices.

The apparatus of the invention may comprise one or more air injectors for agitating the suspension and for providing additional contact surfaces between the wet sludge and dry air, thus accelerating the evaporative part of the drying process. In one embodiment, the invention comprises multiple high volume air injector pipes embedded in a press and connected to a main air manifold, which in turn is connected to an air blower. In the preferred embodiment, the invention comprises multiple high pressure and/or high volume air injector pipes (901) in the side and floor conduits (401) and connected to a main air manifold, which in turn is connected to a high pressure air blower. High volume air injectors are designed to provide large quantities of air to a very wet suspension, and the high pressure air injectors are designed to inject air into thicker, drier suspensions. As mentioned, the air injectors provide the dual purpose of agitating the suspension and accelerating the evaporative drying process. Agitating the suspension helps prevent clogging of the filters by circulating solid deposits away from the filters, and thus accelerates the filtration part of the drying process.

The invention may comprise one or more vibrating elements to agitate the suspension and help prevent filter clogging. The vibrating elements may be any device for providing forceful oscillatory motions that are known in the art. Examples of vibrating elements that may be used as part of the invention include electric motor driven vibrators, air injector rotary ball vibrators, hydraulic vibrators, and piston vibrators or thumpers. One or more vibrating elements may be mounted to the floor or walls of the main tank chamber or to the press (1001). These vibrating elements may be firmly mounted to the walls of the chamber and be disposed throughout the chamber to agitate the sludge therein. Alternatively, vibrating elements may be disposed to vibrate the walls of the chamber itself, thus causing the sludge to be agitated within the chamber. Or the vibrating elements may be mounted to a press, and may cause the press itself to vibrate. Vibrations can be introduced by modulation of an applied vacuum, for example, by pulling a vacuum and releasing it on a rapid time scale.

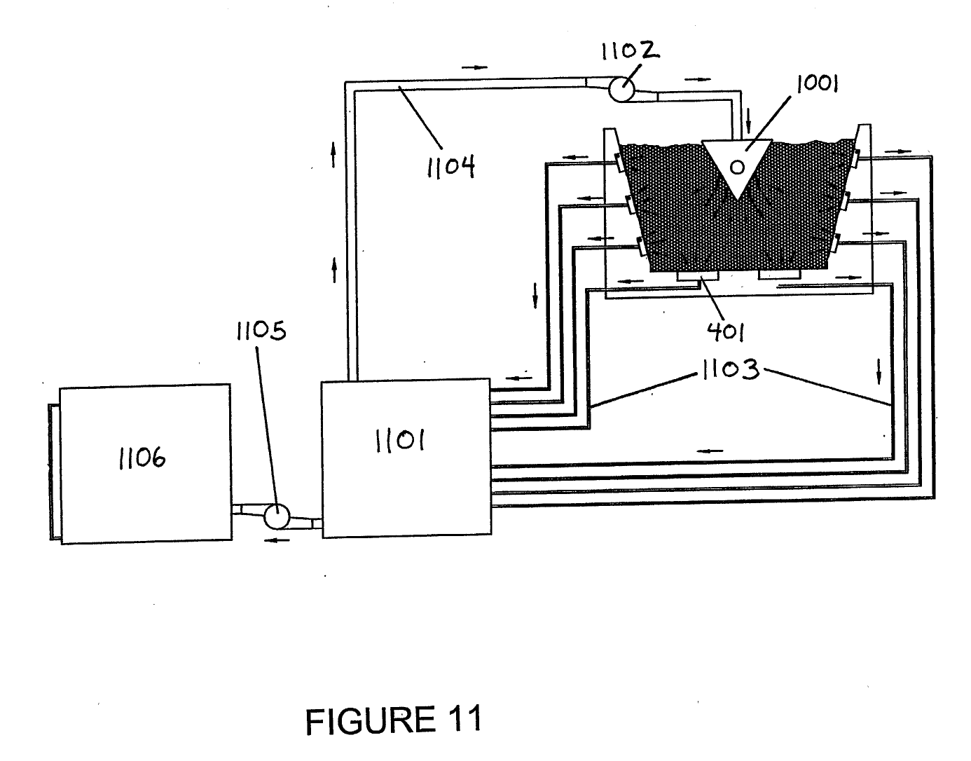

One aspect of the invention comprises a pump system for moving liquids away from the chamber, and for creating a partial vacuum in the chamber. One embodiment of the pump system of the invention is depicted in FIG. 11. In this embodiment, a moisture collection tank (1101) is connected to the conduits (401) through a plurality of water drainage pipes (1103) and into which water expelled from the suspension drains. In the embodiment shown in FIG. 11, a first pump (1102) is used to inject air into the sludge through a press (1001) near the surface of the sludge. A second pump (1105) is used to move liquid from the moisture collection tank (1101) to a moisture holding tank (1106). The moisture holding tank (1106) may include a gauge (not shown) so that the moisture level can be determined. The gauge allows determination of when the holding tank is full and needs to be emptied. Alternatively, instead of the moisture holding tank (1106), or after the water holding tank (1106) is full, the liquid can be expelled to a municipal water treatment system, or a plant water treatment facility, or if it is sufficiently clean, it may be expelled into the environment.

In embodiments of the invention employing a substantially air-tight membrane to cover the sludge-containing chamber, the first pump (1102) is a vacuum pump, used to create a partial vacuum in the moisture collection tank (1101) through a vacuum line (1104). The vacuum propagates through water drainage pipes (1103), into the conduits (401), thus providing a suction force to the sludge and facilitating the de-watering process.

One aspect of the invention is a method for separating liquids from solids, for example, removing water from waste sludges to provide a substantially dry solid material for use in a secondary market. In the preferred method, waste sludge is continuously emptied into one or more main tank chambers as described above. On a regular basis, or when an operator deems it necessary based on the amount of sludge in said chambers, the sludge is covered with a membrane, which is sealed to the walls of the chamber in a substantially air-tight manner. Preferably, the sludge is covered with a membrane on a continuous basis, even during the chamber filling part of the cycle, when the chamber is full, the flow into the chamber is diverted or stopped, and the chamber is sealed with a substantially air-tight seal before the sludge drying part of the cycle. A vacuum is pulled through the conduits of the chamber for a time, preferably until the flow of liquid through the conduits substantially ceases, and then the vacuum is released. The process of pulling a vacuum for a time, then releasing the vacuum, may be repeated several times as required until the remaining solids are sufficiently dry for their intended purpose. If a drier product is required, the process may need to be repeated several times. Often, however, some remaining moisture is desirable, especially for sludges containing finer particulate matter, so that the fine solids can be unloaded and transported with minimal spillage. More pressure can be brought down upon the sludge by use of a hydraulic press.

In order to speed the drying process, the main tank chamber can be heated so that the sludge contained therein is also heated. This increases the rate of evaporative drying. Heat and pressure conditions may be optimally selected by routine experimentation to induce vaporization to speed the drying process. Additionally, air, another gas, or another liquid may be injected into the sludge to speed the drying process, enhance the material, or both.

One embodiment of the invention includes a portable data collector that is a scale model of the entire invention as described in detail above. The portable data collector is designed to determine whether the suspension filter and drying device of the invention would be a suitable replacement for the existing devices of the prior art for any given type of sludge, slurry, or other suspension. Actually testing the device with the sludge generated in a particular industrial application, for example, allows the industry to evaluate whether the device meets the industry's needs for speed of sludge processing, and dryness of final solid product. In this embodiment, the outputs of the temperature sensor, moisture sensor, and an optional dust sensor are input into a computer, which monitors the temperature, moisture level, and dust level during the filtration process. The computer also provides a timing function to measure the amount of time required to achieve a given level of dryness. The industry can then evaluate the benefits of incurring the costs of installing a permanent sludge filter system of the invention based on the data recorded by the computer.

In another embodiment of the invention, a plurality of industrial waste processing units substantially as described herein are monitored and controlled from a single, central monitoring and controlling facility. Measurement devices attached to the sludge processing units of the invention can be adapted to transmit signals to the central monitoring and controlling facility by means readily understood by those skilled in the art, and thus to allow monitoring of key parameters such as sludge level in the chambers and sludge dryness during a drying cycle. The active components of the invention described above (the vacuum system, the air injectors, the heating elements, etc.) can be controlled by signals from the central monitoring and controlling facility. Thus, in this embodiment, a plurality of sludge processors at a plurality of industrial sites can be monitored and controlled from a single facility. This embodiment provides an efficient means of supervising the sludge processors in many different locations by fewer operators than if operators were required to be physically present at each location.

### EXAMPLE

A 100 foot long, 30 foot wide, 5 foot deep chamber, substantially as shown in FIGS. 1-4, is filled with waste sludge from an aluminum manufacturing facility. Water from the sludge is initially allowed to drain under the force of gravity through filters separating conduits in the chamber from the body of the chamber during the process of filling the chamber with the waste sludge. The filters are Mirafi (TM) Filterweave woven geotextile filter #115. A natural rubber membrane is in place over the chamber, and sealed in a substantially air-tight manner using bolts and gaskets. After the chamber is full of waste sludge, a 30 horsepower vacuum pump is used to reduce the pressure within the chamber to about 1 inch Hg (a vacuum of about 29 inches Hg) until a static equilibrium is reached. The vacuum is released for a time until a new static equilibrium is reached. The process of pulling and releasing the vacuum is repeated several times, until the solids in the waste sludge have reached a predetermined level of dryness as indicated by moisture sensors.

Each reference cited above is incorporated herein in its entirety. While the preceding sections describe several embodiments, they are not meant to limit the scope of the invention in any way. It will be apparent to those skilled in the art that various modifications and variations can be made in the apparatus and methods of the invention without departing from their spirit and scope. The following claims are intended to cover modifications and variations of the invention that are within the scope of these claims and their equivalents.

What is claimed is:

1. An apparatus for reducing the percentage of liquid in a liquid and solids mixture comprising:
(a) a holding chamber for receiving a liquid and solids mixture,
(b) a conduit for directing liquid from the liquid and solids mixture away from said chamber,
(c) a filter separating said conduit from said chamber,
(d) a membrane forming a substantially air-tight seal over said chamber, and
(e) a means for reducing pressure in said conduit;
wherein reduced pressure in said conduit causes liquid to be drawn from said holding chamber through said filter into said conduit.

2. The apparatus of claim 1, further comprising a heating means, wherein said heating means elevates the temperature of the liquid and solids mixture.

3. The apparatus of claim 2, wherein said chamber comprises said heating means.

4. The apparatus of claim 3, wherein the heating means is disposed within a wall of said chamber.

5. The apparatus of claim 2, wherein said heating means is disposed within said membrane.

6. The apparatus of claim 2, further comprising an air injector, wherein said air injector forces air into the mixture.

7. The apparatus of claim 6, wherein said air injector is disposed within said chamber.

8. The apparatus of claim 7, wherein said membrane comprises said air injector.

9. The apparatus of claim 8, further comprising a vibrating means for agitating the liquid and solids mixture.

10. The apparatus of claim 9, further comprising a moisture collection tank disposed to receive liquid from the liquid and solids mixture through said conduit.

11. The apparatus of claim 10, further comprising a moisture holding tank disposed to receive liquid from said moisture collection tank.

12. The apparatus of claim 2, further comprising a temperature probe for measuring a temperature of the liquid and solids mixture.

13. The apparatus of claim 2, further comprising a thermostat for controlling activation of said heating means.

14. The apparatus of claim 13, wherein the apparatus is a portable scale model of an industrial size apparatus.

15. The apparatus of claim 13, wherein said thermostat is set to between about 100° F. and 220° F.

16. A method for reducing the percentage of liquid in a liquid and solids mixture comprising the steps of:
(a) injecting the mixture into a chamber comprising a conduit and a filter separating said conduit from said chamber;
(b) positioning a membrane over said chamber such that said membrane forms a substantially air-tight seal over said chamber;
(c) reducing pressure within said conduit below atmospheric pressure; and
(d) recovering a particulate material from said chamber,
wherein reducing pressure within said conduit causes liquid to flow from said chamber into said conduits.

17. The method of claim 16, further comprising the step of heating the liquid and solids mixture in said chamber.

18. The method of claim 17, wherein the liquid and solids mixture is heated to between 100° F. and 220° F.

19. The method of claim 17, further comprising the step of injecting air into the liquid and solids mixture.

20. The method of claim 19, further comprising the step of agitating the liquid and solids mixture.

21. The method of claim 20, further comprising the step of collecting liquid in a collecting tank.
